(19) United States
(12) Patent Application Publication
(10) Pub. No.: US 2003/0130960 A1
(43) Pub. Date: Jul. 10, 2003

(54) Bridging service for security validation within enterprises

(76) Inventors: John D. Fraser, Golden Valley, MN (US); Peter L. Palmer, St. Paul, MN (US); Jeffry H. Hallgren, Excelsior, MN (US)

Correspondence Address: SHUMAKER & SIEFFERT, P. A., 8425 SEASONS PARKWAY, SUITE 105, ST. PAUL, MN, 55125, US

(21) Appl. No.: 10/307,233

(22) Filed: Nov. 27, 2002

Related U.S. Application Data
(60) Provisional application No. 60/334,312, filed on Nov. 28, 2001.

(51) Int. Cl. G06F 17/60

(52) U.S. Cl. 705/75; 705/76

(57) ABSTRACT

The invention provides techniques for validating security credentials locally within an enterprise. For example, a trust server within the enterprise intercepts a validation request from a secure electronic email service being used by a client within the enterprise. The trust server accesses security credential information, which may be maintained in a directory, to answer for the validation request. When the trust server is unable to answer the validation request, the trust server queries a bridge service provider, which associates the trust server with trust servers maintained by other enterprises, for the security credential information necessary for validation. The bridge service provider forwards the query to the appropriate one the trust servers of another enterprise. The trust server of the other enterprise returns the necessary security credential information, which the bridge service provider relays to the querying trust server for validation.

This application claims priority from U.S. Provisional Application Serial No. 60/334,312, filed Nov. 28, 2001, the entire content of which is incorporated herein by reference.

### TECHNICAL FIELD

The invention relates to computer networks and, more particularly, to secure electronic communications via computer networks.

### BACKGROUND

Whether fearful of email eavesdropping, being hacked in enterprise networks or accidentally losing important information, many companies and government organizations continue to invest huge sums of money on private networks, virtual private networks (VPNs), dialup modem banks, and similar technologies, to sidestep or ameliorate problems associated with Internet usage. Nevertheless, broad corporate acceptance of network-based communications and other operations involving sensitive information has been slow due to the lack of a comprehensive security system that provides end-to-end trust and reliability for important business information flows.

Often an enterprise may resort to a wide variety of security models in an attempt to address these concerns. Many enterprises, for example, may rely on security models that operate based on exchanging public-private key pairs, cooperating on setting up “private” communication lines, or agreeing to a specific Public Key Infrastructure (PKI) implementation. The use of a wide variety of security models leads to a lack of integration and scalability. Enterprises that use different Certificate Authorities, for example, may not be able to securely communicate with one another since each enterprise uses a different type of digital certificate.

### SUMMARY

In general, the invention is directed to techniques for validating security credentials, also referred to as authentication, across multiple enterprises. In particular, the techniques allow for validation of security credentials locally within an enterprise via a bridging service. A trust server maintained locally within an enterprise may validate security credentials for clients within the enterprise by accessing security credential information of other trust servers via the bridging service. The term “trust server” is used to refer to a server that participates in validation of security credentials via the bridging service.

The trust server may, for example, intercept a validation request from an electronic service being used by a client. The electronic service may include, for example, a secure electronic email service. The trust server accesses security credential information, which may be stored in a directory, for example, to determine an answer for the validation request. The directory may include information, such as a digital certificate, contact information, an email address, and other information that uniquely identifies the respective client.

If the trust server is unable to answer the validation request, the trust server queries a bridge service provider external to the enterprise for the security credential information necessary for validation. The bridge service provider associates the trust server with trust servers maintained by other enterprises, and forwards the query to the appropriate one of the trust servers maintained by the other enterprises. The trust server of the other enterprise returns the necessary security credential information, which the bridge service provider relays to the querying trust server for validation. Alternatively, the bridge service provider may answer the query on behalf of enterprises that are clients of the bridge service provider. For example, the bridge service provider may maintain a directory of security credential information of enterprises that are members and access that directory to search for the appropriate security credential information. In this manner, validation (or authentication) is performed locally within enterprises.

In one embodiment, the invention provides a system comprising a client service executing within an enterprise and a trust server to receive validation requests from the client service and perform security credential validation within the enterprise.

In another embodiment, the invention provides a method comprising receiving a validation request from a client service within an enterprise and performing security credential validation within the enterprise using a trust server.

The invention may provide one or more advantages. The bridging service may allow enterprises to obtain validation security locally without cooperation between the enterprises to establish common security models. For example, the trust servers may provide validation of security credentials without exchanging public-private key pairs, cooperating to set up private lines, or agreeing to a specific Public Key Infrastructure (PKI) implementation. In this manner, bridge service providers may interconnect enterprises using different security environments allowing for a high degree of scalability. Further, the bridge service providers may provide the ability to use multiple types of digital certificates from various Certification Authorities.

Further, since the trust servers are maintained by the enterprises themselves, the “trust” in the security of the system need not rely exclusively on external third parties, such as a certificate authority that issues the digital certificates used by the clients of the enterprises. As a result, the established trust is distributed and managed locally by the enterprises that are members of the bridging service. In this manner, the techniques may be viewed as shifting the ultimate control and focus of network trust inward to enterprises from these external parties.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a trust domain that provides substantially instant validation of security credentials across multiple enterprises.

FIG. 2 is a block diagram illustrating a trust domain in further detail.

FIG. 3 is a block diagram illustrating a trust server that validates security credentials locally within an enterprise.

FIG. 4 is a block diagram illustrating a bridge service provider that links trust servers together to form a trust domain, such as trust domain of FIG. 1.

FIG. 5 is a flow diagram illustrating instant validation of security credential information locally within an enterprise.

### DETAILED DESCRIPTION

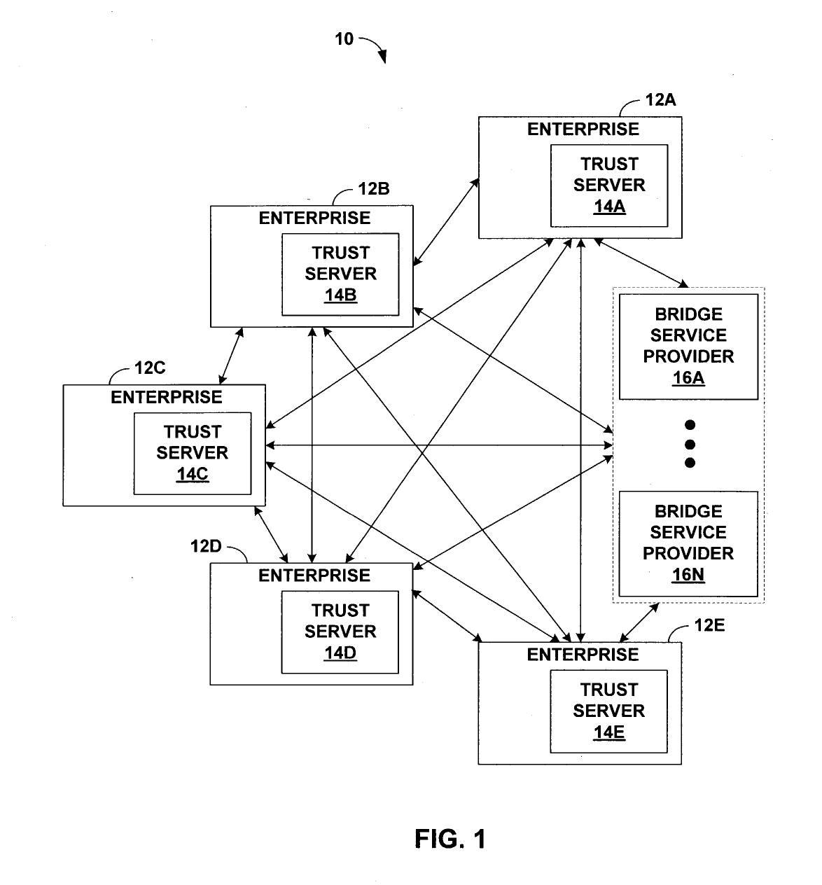

FIG. 1 is a block diagram illustrating a trust domain 10 that provides substantially instant validation of security credentials across multiple enterprises 12A-12E (“12”). More particularly, enterprises 12 include trust servers 14A-14E (“14”), respectively, which validate security credentials for clients within trust domain 10. The term “trust server” is used to refer to a server that participates in validation of security credentials within trust domain 10.

Each of enterprises 12 and, more particularly trust servers 14 associated with enterprises 12, are coupled to at least one of bridge service providers 16A-16N (“16”). Bridge service providers 16 serve to link trust servers 14 of enterprises 12 together, in turn creating trust domain 10. When a service provided to a client of an enterprise 12 requires validation of security credential information that is maintained by a trust server 14 within another one of enterprises 12, for example, one or more bridge service providers 16 provide the link through which the client obtains security credential information.

Trust domain 10 allows clients within one of enterprises 12 to obtain validation of security credentials, e.g., without cooperation between enterprises 12 to establish a common security model. For instance, enterprises 12 may provide security credential validation without exchanging public-private key pairs, cooperating to set up private lines, or agreeing to a specific Public Key Infrastructure (PKI) implementation. In this manner, bridge service providers 16 may interconnect enterprises 12 using different security models. The interconnection of enterprises 12 using different security models may provide the ability to use multiple types of digital certificates as well as check digital certificates from various Certification Authorities. For example, trust domain 10 may be configured to support X.509 certificates, along with other types of certificates or new technologies by using eXtensive Markup Language (XML) to define Standard Object Access Protocol (SOAP) calls. For instance, SOAP calls may be used to validate X.509 certificates, Pretty Good Privacy (PGP) keys, Kerberos keys, or to find a digital certificate of a client. Bridging service providers 16 allows for a high degree of scalability by reducing the number of direct interconnections needed for secure communication between enterprises 12.

As mentioned above, trust servers 14 may validate security credentials within trust environment 10. For example, trust server 14A within enterprises 12A may validate security credentials for clients within enterprises 12A. Trust servers may further provide security credentials for use in validation performed by other trust servers 14. For example, trust server 14A may provide security credentials to trust server 14B through bridge service providers 16 for use in validation for a service within enterprise 14B. Although in FIG. 1 each of enterprises 12 includes a single trust server 14, enterprises 12 may include more than one trust server 14 to provide redundancy and ensure reliability.

More specifically, one of trust servers 14, such as trust server 14A, receives a validation request from a service being used by a client. Trust server 14A, for example, may be configured to intercept a validation request, which is usually sent to a third party for validation processing, of a client within enterprise 14A and answers the validation request locally within enterprise 12. Trust server 14A may, for example, be linked to or be a part of a certificate authority system within enterprise 12A and answer the validation request using a local certificate revocation list (CRL) or an online certificate status protocol (OCSP) responder. Alternatively, trust server 14A may be loaded with the security credential information in a directory, such as a cache, or other storage mechanism.

When trust server 14A is unable to answer the validation request, trust server 14A forwards a query for the security credential information necessary for validation to bridge service provider 16 associated with the respective trust server 14. Bridge service provider 16 associated with the respective trust server 14 may answer the query on behalf of another enterprise 12. Bridge service providers 16 that are not able or not authorized to answer the query on behalf of the other enterprise 12 forward the query for the security credential information to another bridge service provider 16 or trust server 14 that can obtain the security credential information. Bridge service providers 16 forward the query by accessing a trust server 14 associated with another one of enterprises 12 and obtaining the necessary security credential information from trust server 14 associated with the other enterprise 12. Bridge service providers 16 relay the security credential information to trust server 14A associated with the client that made the validation request.

The security credentials may be a digital certificate or a technology like biometrics that uniquely binds a digital identity to an individual client. The security credential information that bridge service providers 16 relay to trust server 14A may include, for example, validity dates of the digital certificate, the status of the digital certificate, i.e., active or revoked, XML-structured contact information for the client associated with the digital certificate, and the like. The communications between the clients, trust servers 14, and bridge service providers 16 can be, for example, a series of simple object access protocol (SOAP) calls. Trust server 14 associated with the client receives the security credential information, parse the security credential information, and processes the security credential information to control the service being used. For instance, trust server 14 may allow the client to send a secure email when the security credentials are validated with the obtained security credential information or prevent the client from sending the email when the security credentials are not validated.

A single source of authentication may not be preferred from a privacy perspective. Initial identity may be provided to clients that act in an enterprise-to-enterprise role, and not for individual clients. Most clients, for example, are comfortable with a publicly known enterprise identity, especially one that does not contain any personal information about the client. Example usages of this type of trust domain for validation of security credentials include ordering products for enterprises 12, signing an electronic contracts, purchasing with a credit card, ordering products over the web, sending medical records between providers, withdrawing money from your local ATM system, voting, betting, getting licenses from various local, state and federal agencies, proving age when buying liquor, paying parking meters, paying for pay-telephone calls, paying for public transportation, and the like.

Enterprises 12 within trust domain 10 may, however, require a stricter security model for validation of security credentials. Some examples of trust domains that may require stricter security models include a health care insurance company that accepts claims signed only by certificates issued under specific policies, a pharmacy chain that accepts electronic prescriptions that comply with a Pharmacy Association policy, state government agencies allow people to vote with certificates that fall within a group of specific policies and are verifiable at point of voting, and organizations that accept purchase orders above a certain dollar amount only if digitally signed.

Trust domain 10 may be created, for example, by contractual arrangements between enterprises 12 and bridge service providers 16. Multiple vendors may provide the bridging service, using standards that are agreed to by enterprises 12. Further, the standards under which the bridging services operate may provide for national and perhaps international interoperability. The vendors providing the bridging services may be contractually bound to operate in a professional manner and may further be required to upgrade the bridging systems as new features are added. The vendors providing the bridging services may further be audited on a regular basis. The regulations imposed on the vendors providing the bridging services, along with the contracts entered by the vendors, instill a sense of trust in the bridging vendors.

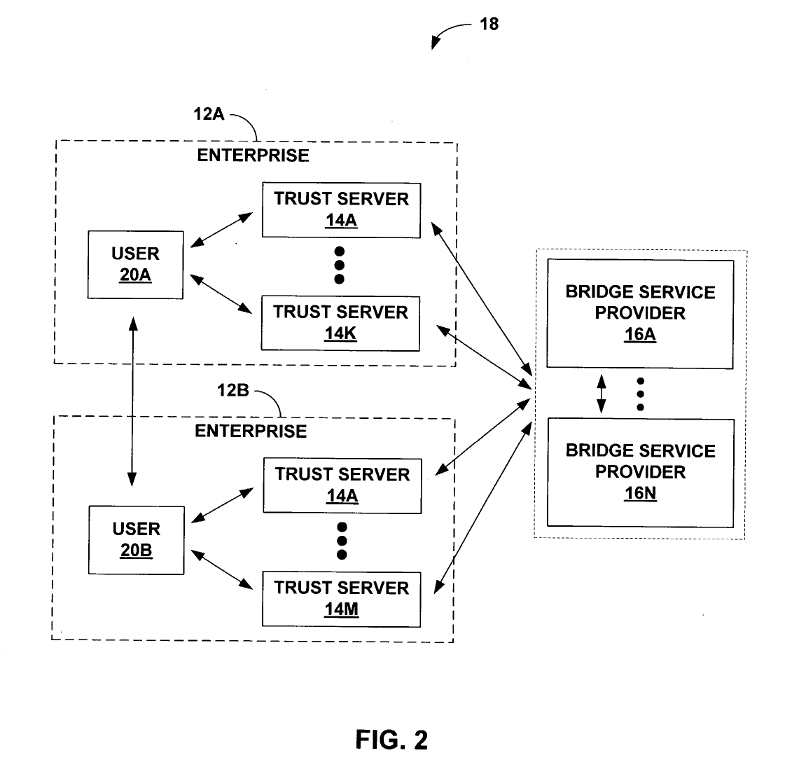

FIG. 2 is a block diagram illustrating another example trust domain 18 that provides substantially instant validation of security credentials across multiple enterprises in further detail. Trust domain 18 includes enterprises 12A and 12B (“12”). Each of enterprises 12 includes a corresponding plurality of trust servers 14. In the example of FIG. 1, enterprise 12A includes trust servers 14A-14K and enterprise 12B includes trust servers 14A-14M.

Each of trust servers 14 of enterprises 12 corresponds to one or more bridge service providers 16A-16N (“16”). Trust servers 14 of enterprise 12A may, for example, correspond to bridge service provider 16A while trust servers 14 of enterprise 12B correspond to bridge service provider 16N. Alternatively, trust servers 14 of enterprise 12A may correspond the same bridge service provider 16 as trust servers 14 of enterprise 12B. However, all of trust servers 14 within each of enterprises 12 must not correspond to the same bridge service provider 16. For example, a portion of trust servers 14 of enterprise 12A may correspond to bridge service provider 16A while the rest of trust servers 14 of enterprise 12A correspond to bridge service provider 16N.

Trust servers 14 communicate with corresponding bridge service providers 16 in order to validate security credentials for clients. Bridge service providers 16 may further communicate with each other in order to identify security credential information necessary for validation. For example, bridge service providers 16 may communicate when trust servers 14 associated with the sender and receiver correspond to different bridge service providers 16.

As described above, the trust domains may support many client services. One such client service supported by trust domain 18, which is described for purposes of illustration, is secure email services. Other client services include electronic file sharing, network storage, secure web folders, secure web access, and the like. Client services 20 within enterprises 12 can use the infrastructure of trust domain 18 to lookup other clients, find digital certificates associated with the other clients, and email the clients with secure multipurpose internet mail extensions (S/MIME) emails. At the receiving end, the receiving client can validate included digital signatures using the same mechanism.

For example, a client service 20A of enterprise 12A starts a communication process by accessing a desired service locally. The communication process may include electronic mail (email), document signing, transferring files, or the like. For example, client service 20A of enterprise 12A may wish to send a secure email to client service 20B of enterprise 12B and, in turn, accesses a local secure email service. The local secure email service may, for example, be a software program on a device operated by user 20A. Before the secure email service sends the email, the email service queries a validation request, such as a request for validation of active digital certificates associated with the source client service 20A and destination client service 20B. One of trust servers 14 of enterprise 20A intercepts the request for validation of security credentials.

Trust server 14 that intercepted the validation request accesses stored security credential information to determine whether an answer to the validation request may be granted. Trust server 14 may, for example, be linked to or be a part of a certificate authority system within enterprise 12A and answer the validation request using a local certificate revocation list (CRL) or an online certificate status protocol (OCSP) responder. Alternatively, trust server 14A may be loaded with the security credential information in a cache or other storage mechanism. Trust server 14 may, for example, access the cache of security credentials maintained within enterprise 12A.

When the intercepting trust server 14 cannot grant the validation request, trust server 14 may query a corresponding bridge service provider 16 in order to retrieve the necessary security credential information to grant the validation. Bridge service provider 16 obtains the security credential information necessary for validation of the security credentials by the intercepting trust server 14. Each of bridge service providers 16 may maintain a directory of members of bridge service provider 16. The directory may include, for example, a unique identifier, a certificate number, and a reference for security credential information location for each of the members. The reference for security credential information may, for instance, be a lightweight directory access protocol (LDAP) directory. Alternatively, bridge service providers 16 may answer the queries on behalf of their clients by running local trust servers. The functionality of the trust server run by bridge service providers 16 is the same as trust servers 14 of enterprises 12. For example, if trust servers 14 of enterprises 12 correspond to the same bridge service provider 16, bridge service provider 16 may maintain have the necessary security credential information.

If bridge service provider 16 corresponding to the intercepting trust server 14 does not have the necessary security credential information and trust servers 14 of enterprises 12 correspond to the same bridge service provider 16, bridge service provider 16 may query the trust server 14 of enterprise 12B to obtain the necessary security credential information. If trust servers 14 of enterprises 12 correspond to different bridge service providers 16, bridge service provider 16 associated with enterprise 12A may query another bridge service provider 16 associated with enterprise 12B to obtain the security credential information.

Upon receiving the security credential information, intercepting trust server 14 associated with client service 20A parses the security credential information and processes the security credential information to control the communication process being used by client service 20A. For instance, intercepting trust server 14 may allow the client service to send a secure email when the security credentials are validated with the obtained security credential information or prevent the client service from sending the email when the security credentials are not validated. Upon validating the security credentials trust server 14 logs the validation to provide an audit trail.

A similar process occurs on the receiving end of the communication process. More particularly, client service 20B receives the communication, e.g., a secure email. Client service 20B accesses the email service to open the email. Before opening the email, the email service queries a validation request that is intercepted by a corresponding trust server 14 of enterprise 12B. Trust server 14 obtains security credential information from within trust server 14 itself or via bridge service provider 16. Trust server 14 associated with client service 20B parses the security credential information and processes the security credential information to control the process being used by client service 20B.

The techniques described above for secure email services may be extended to a number of different client services. The clients can be any type of system. The client could be a door that checks the validity of a wireless digital certificate in order to determine whether to unlock or remain locked. The client could also be a car with a local trust server built-in that verifies a wireless digital certificate. The client may be a desktop computer, cell phone, ATM machine, credit card verifiers, security servers, access control systems, smart card readers, or any other type of system.

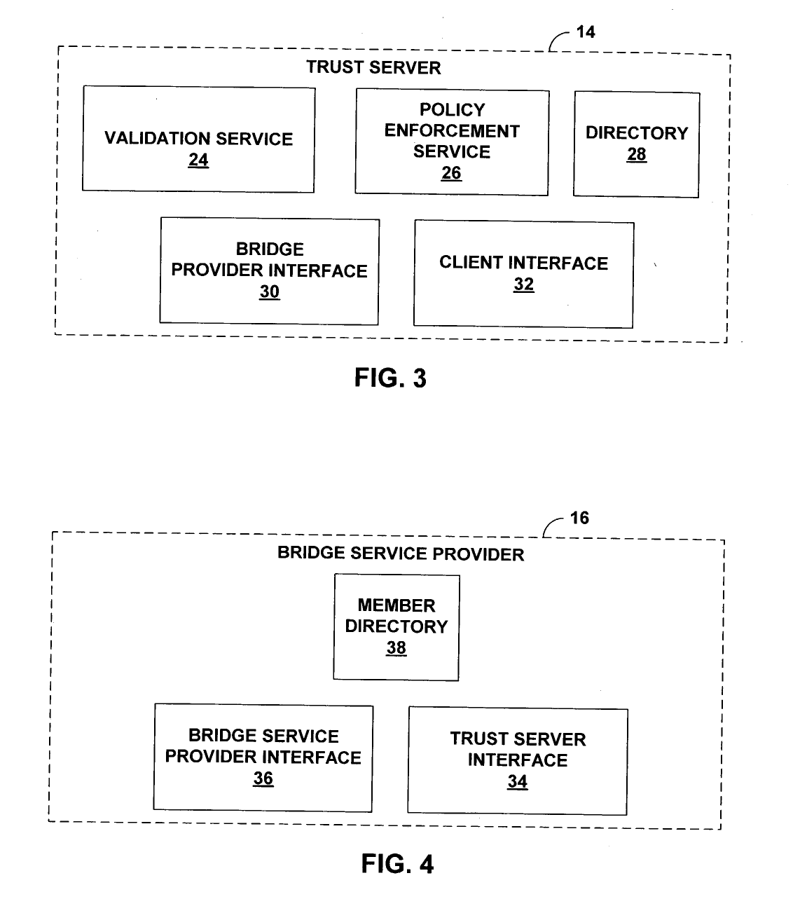

FIG. 3 is a block diagram illustrating a trust server 14 that validates security credentials locally within an enterprise 12. More specifically, trust server 14 intercepts validation requests to external validation services and answers the validation requests locally. Trust server 14 includes a client service interface 24, a validation service 26, a directory 28, a bridge provider interface 30, and a policy enforcement service 32.

Client service interface 24 couples client services to trust server 14 to allow trust server 14 to intercept validation requests from client services and perform substantially instant validation. Client service interface 24 may couple client service software, such as the secure email client software described above, to trust server 14. Client interface 24 may be, for example, an application program interface (API).

Upon trust server 14 intercepting a validation request, validation service 26 begins the validation process. Validation process 26 may access a directory 28 to search for security credential information for the validation process. Directory 28 may include, for example, validate dates of the digital certificate, the status of the digital certificate (i.e., active or revoked), XML-structured contact information for the client associated with the digital certificate, and any client security credentials information specific to a service. For example, for a purchasing service, client security credentials for the specific service may include an amount a client has the authority to commit the enterprise to in purchasing or contracting.

When validation process 26 finds the necessary information within directory 28, validation process 26 parses the security credential information and processes the security credential information in order to control the client service. If validation process 26 validates the security credentials, the client service may continue with the services provided.

When validation process does not find the necessary security credential information, trust server 14 communicates a query for the security credential information to a bridge service provider 16 via bridge provider interface 30. Bridge provider interface 30 may also provide a communication path by which bridge service providers 16 may query trust server 14 for security credential information. Bridge provider interface 30 may also be an application programmable interface (API).

Policy enforcement service 32 controls the sharing of security credential information with other enterprises via bridge service providers 16. For instance, policy enforcement service 32 may allow a first enterprise 16 with a first permission level to security credential information and may grant a second enterprise 16 with less permission than the first.

FIG. 4 is a block diagram illustrating a bridge service provider 16 that links trust servers 14 together to form a trust domain, such as trust domain 10 of FIG. 1. Bridge service provider 16 includes a trust server interface 34, a bridge provider interface 36, and a member directory 38.

Bridge service provider 16 receives queries from trust servers 14 via trust server interface 34. Bridge service provider 16 may access memory directory 38 in response to the query to obtain security credential information for the validation. Memory directory 38 may include, for example, a unique identifier, a certificate number, and a reference for security credential information location for each of the members. The reference for security credential information may, for instance, be a lightweight directory access protocol (LDAP) directory. Bridge service provider 16 may relay security credential information obtained in response to the queries to trust servers 14 via trust server interface 34.

Bridge service provider 16 may also forward the queries to a trust server 14 of another enterprise and relay the responses to the querying trust server via trust server interface 34. Although a single trust service interface 34 is illustrated in the example of FIG. 4, bridge service provider 16 may include more than one trust service interface 34 in order to interface different security models of different enterprises 12.

Bridge service provider 16 may also forward the queries from trust servers 14 to another bridge service provider 16 via bridge provider interface 36. The information received from the other bridge service provider 16 may is relayed back to bridge service provider 16 via bridge provider interface 36 and then further relayed to the querying trust server 14 via trust server interface 34.

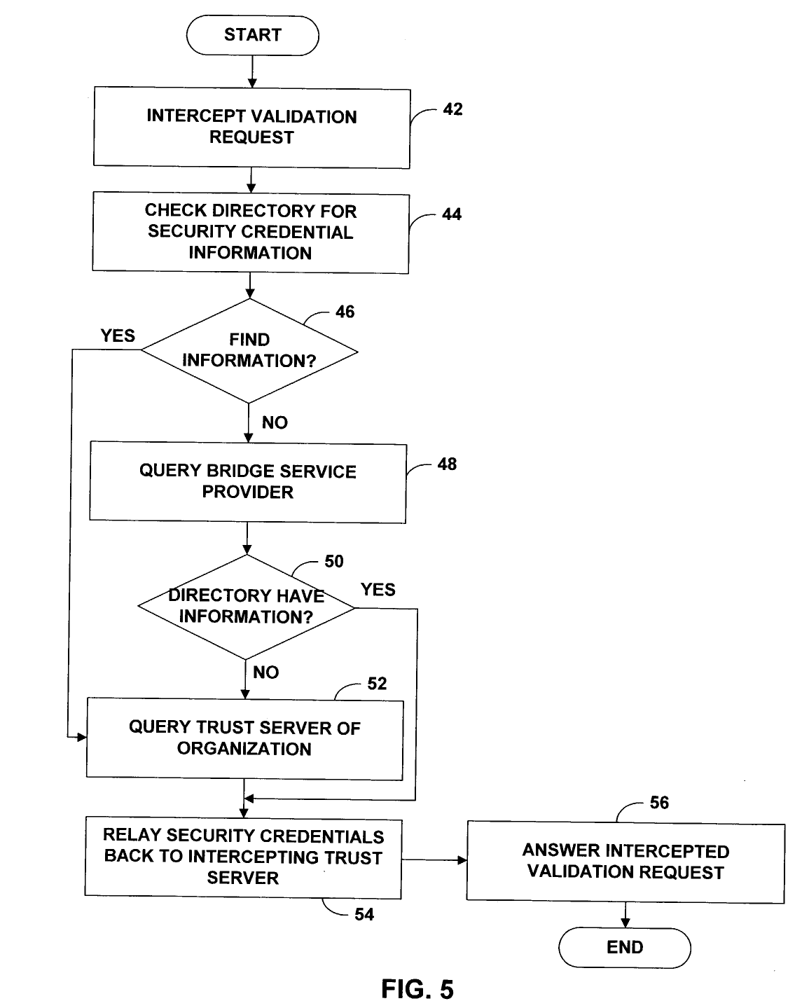

FIG. 5 is a flow diagram illustrating instant validation of security credential information locally within an enterprise 12. Trust server 14 intercepts a validation request from a client (42). The validation request may, for example, be intercepted in route to an external validation service.

Trust server 14 checks locally for the security credential information necessary to answer the validation request (44). Trust server 14 may, for example, be linked to or be a part of a certificate authority system within enterprise 12 and answer the validation request using a local certificate revocation list (CRL) or an online certificate status protocol (OCSP) responder. Alternatively, trust server 14 may be loaded with the security credential information in a directory, such as a cache, or other storage mechanism.

When trust server 14 does not have the necessary credential information, trust server 14 queries a bridge service provider 16 associated with trust server 14 (46, 48). Bridge service provider 16 determines whether a member directory has the necessary security credentials for the validation request (50). The directory may include, for example, a unique identifier, a certificate number, and a reference for security credential information location for each member of bridge service provider 16. The reference for security credential information may, for instance, be a lightweight directory access protocol (LDAP) directory. Alternatively, bridge service provider 16 may answer the query on behalf of their clients by running local trust servers.

When bridge service provider 16 does not have the necessary security credential information, bridge service provider 16 queries a trust server 14 of the enterprise that may have the necessary security credential information (52). Alternatively, another bridge service provider 16 maybe queried in hopes of trying to obtain the necessary security credential information.

When the bridge service provider 16 obtains the security credential information from the member directory or from the trust server of the other enterprise, bridge service provider 16 relays the security credential information back to the trust server 14 that intercepted the validation request (54). Trust server 14 parses the security credential information, processes the security credential information, and answers the validation request in accordance with the security credential information (56). When trust server 14 grants the validation request, the client service that sent the validation request provides the client service.

Various embodiments of the invention have been described. These and other embodiments are within the scope of the following claims.

1. A system comprising:
a client service executing within an enterprise; and
a trust server to receive validation requests from the client service and perform security credential validation within the enterprise.

2. The system of claim 1, wherein the trust server intercepts validation requests intended for external validation services.

3. The system of claim 1, wherein the trust server obtains security credential information for use in the security credential validation from within the enterprise.

4. The system of claim 3, wherein the trust server obtains the security credential information from one of a local certificate revocation list (CRL), an online certificate status protocol (OCSP) response, and a cache.

5. The system of claim 1, further comprising a bridge service provider to link the trust server with trust servers of other enterprises.

6. The system of claim 5, wherein the trust server queries the bridge service provider to obtain security credential information for use in validation within the enterprise.

7. The system of claim 6, wherein the trust server queries the bridge service provider when the security credential information is not found within the enterprise.

8. The system of claim 5, wherein the bridge service provider maintains a member directory and accesses the member directory to obtain the security credential information.

9. The system of claim 8, wherein the member directory includes a unique identifier, a certificate number, and a reference for a location of security credential information for each of the members.

10. The system of claim 9, wherein the reference for the location of security credential information includes a lightweight directory access protocol (LDAP) directory.

11. The system of claim 5, wherein the bridge service provider queries one of the trust servers of another enterprise for the security credential information.

12. The system of claim 11, wherein the enterprise of the querying trust server and the enterprise of the other trust server operate in different trust environments.

13. The system of claim 12, wherein the different trust environments include Public Key Infrastructure (PKI), Pretty Good Privacy (PGP), and Kerberos.

14. The system of claim 5, wherein the bridge service provider queries another bridge service provider for the security credential information.

15. The system of claim 5, wherein the bridge service provider relays the security credential information to the trust server that initiated the query.

16. The system of claim 1, wherein the trust server validates certificates from various Certification Authorities.

17. The system of claim 1, wherein the trust server logs validations to provide an audit trail.

18. The system of claim 1, wherein the client service includes a secure electronic mail (email) service, securely exchanging information, such as electronic mail, electronic file sharing, network storage, secure web folders, secure web access, and the like.

19. A method comprising:
receiving a validation request from a client service within an enterprise; and
performing security credential validation within the enterprise using a trust server.

20. The method of claim 19, wherein receiving the validation request from the client service includes intercepting a validation request from the client service to an external validation services.

21. The method of claim 19, further comprising obtaining security credential information for use in performing security credential validation.

22. The method of claim 20, wherein obtaining security credential information for use in performing security credential validation includes obtaining security credential information within the enterprise.

23. The method of claim 22, wherein obtaining security credential information within the enterprise includes obtaining security credential information from one of a local certificate revocation list (CRL), an online certificate status protocol (OCSP) response, and a cache.

24. The method of claim 23, further comprising coupling the trust server to a bridge service provider to link the trust server with trust servers of other enterprises.

25. The method of claim 24, further comprising querying the bridge service provider to obtain security credential information for performing security credential validation.

26. The method of claim 24, wherein the bridge service provider obtains security credential information from a member directory.

27. The method of claim 26, wherein the member directory includes a unique identifier, a certificate number, and a reference for a location of security credential information for each of the members.

28. The method of claim 24, further comprising forwarding the query to one of the trust servers of another enterprise to obtain security credential information

29. The method of claim 28, wherein the enterprise of the querying trust server and the enterprise of the other trust server operate in different trust environments.

30. The method of claim 29, wherein the different trust environments include Pretty Good Privacy (PGP) and Kerberos.

31. The method of claim 24, further comprising forwarding the query to another bridge service provider to obtain credential information.

32. The method of claim 24, further comprising relaying the security credential information to the trust server that initiated the query.

33. The method of claim 19, further comprising:
parsing the security credential information; and
processing the parsed security credential information to answer the validation request.

34. The method of claim 19, further comprising logging validation requests to provide an audit trail.

35. The method of claim 19, wherein performing security credential validation includes performing security credential validation for certificates from various Certification Authorities.

36. The method of claim 19, wherein the trust server is associated with the client service.

37. The method of claim 19, wherein the client service includes a secure electronic mail (email) service, securely exchanging information, such as electronic mail, electronic file sharing, network storage, secure web folders, secure web access, and the like.

38. The method of claim 19, wherein the client service executes on a network device.
